(19) United States
(12) Patent Application Publication
(10) Pub. No.: US 2025/0097662 A1
(43) Pub. Date: Mar. 20, 2025

(54) ACOUSTIC CONTROL APPARATUS, ACOUSTIC CONTROL METHOD, AND NON-TRANSITORY COMPUTER-READABLE STORAGE MEDIUM

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Tatsuhiko GOTO, Kawasaki Kanagawa (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/583,634

(22) Filed: Feb. 21, 2024

(30) Foreign Application Priority Data
Sep. 19, 2023 (JP) 2023-151550

(51) Int. Cl. H04S 7/00

(52) U.S. Cl. CPC H04S 7/307; H04S 7/302; H04S 2400/11; H04S 2400/13

(57) ABSTRACT

According to one embodiment, an acoustic control apparatus includes a processor. The processor calculates a frequency characteristic of a filter from 1) a complex volume velocity of a sound radiated from each point sound source based on the number of point sound sources in a simulated rotating sound source and a lobe mode of the simulated rotating sound source, and 2) an acoustic transfer function between a sound receiving point and each point sound source, which is based on a radius of a circle formed by the point sound sources, a horizontal distance between a center of the circle and the sound receiving point, and a vertical distance between the center of the circle and the sound receiving point. The processor calculates the filter from the frequency characteristic of the filter. The processor stores the filter in a storage.

### CROSS-REFERENCE TO RELATED APPLICATIONS

This application is based upon and claims the benefit of priority from the Japanese Patent Application No. 2023-151550, filed Sep. 19, 2023, the entire contents of which are incorporated herein by reference.

### FIELD

Embodiments described herein relate generally to an acoustic control apparatus, an acoustic control method, and a storage medium.

### BACKGROUND

There is known a sound image localization technique for localizing a sound image in a space around a user using various kinds of acoustic reproduction devices such as loudspeakers. For sound image localization in the azimuth direction with respect to the user as the center, for example, the difference of arrival times of sounds radiated from two or more omnidirectional loudspeaker groups arranged on a horizontal plane to the two ears of the user is used. On the other hand, there is a demand for performing sound image localization in the elevation direction with respect to the user as the center using a simple configuration.

Here, as for a sound arriving from a flight vehicle with rotor blades, like a helicopter or a drone, it can easily be found from what height the sound has arrived. This is probably because a sound from a rotating sound source can easily be localized in the elevation direction because of human auditory characteristics. Sound image localization simulating a sound from a rotating sound source is considered to be effective in sound image localization in the elevation direction of the user.

### BRIEF DESCRIPTION OF THE DRAWINGS

FIG. 1 is a view showing the configuration of an acoustic control system according to the embodiment.

FIG. 2 is a block diagram showing the configuration of an example of an acoustic control apparatus.

FIG. 3 is a view showing the hardware configuration of an example of the acoustic control apparatus.

FIG. 4 is a flowchart showing calculation processing of a rotating sound source correction filter by the acoustic control apparatus.

FIG. 5 is a view showing an input screen of an example.

FIG. 6A is a schematic view of a rotating sound source of an example.

FIG. 6B is a schematic view of a simulated rotating sound source according to the embodiment.

FIG. 7 is a view showing a space in which the simulated rotating sound source is arranged.

FIG. 8A is a view showing a change of a frequency characteristic by a change of Ra/RR.

FIG. 8B is a view showing a change of a frequency characteristic by a change of Ra/RR.

FIG. 9A is a view showing a change of a frequency characteristic by a change of a rotation mode.

FIG. 9B is a view showing a change of a frequency characteristic by a change of a rotation mode.

FIG. 10A is a view showing a change of a frequency characteristic by a change of a low-frequency volume balance.

FIG. 10B is a view showing a change of a frequency characteristic by a change of a low-frequency volume balance.

FIG. 11 is a view showing how to calculate the frequency characteristic of a filter in the presence of a floor.

FIG. 12A is a Bode diagram showing a gain characteristic calculated from the frequency characteristic of a filter with an elevation angle of 45 deg.

FIG. 12B is a Bode diagram showing a phase characteristic calculated from the frequency characteristic of a filter with an elevation angle of 45 deg.

FIG. 12C is a view showing the time characteristic of a rotating sound source correction filter for an elevation angle of 45 deg created from the gain characteristic shown in FIG. 12A and the phase characteristic shown in FIG. 12B.

### DETAILED DESCRIPTION

In general, according to one embodiment, an acoustic control apparatus includes a processor. The processor calculates a frequency characteristic of a filter to be convolved in an acoustic signal to be input to a loudspeaker from 1) a complex volume velocity of a sound radiated from each point sound source based on the number of point sound sources in a simulated rotating sound source represented by a plurality of point sound sources arranged on a circumference and a lobe mode of the simulated rotating sound source, and 2) an acoustic transfer function between a sound receiving point and each point sound source in a space in which the sound receiving point and the simulated rotating sound source are arranged, which is based on a radius of the circle, a horizontal distance between a center of the circle and the sound receiving point, and a vertical distance between the center of the circle and the sound receiving point. The processor calculates the filter from the frequency characteristic of the filter. The processor stores the filter in a storage.

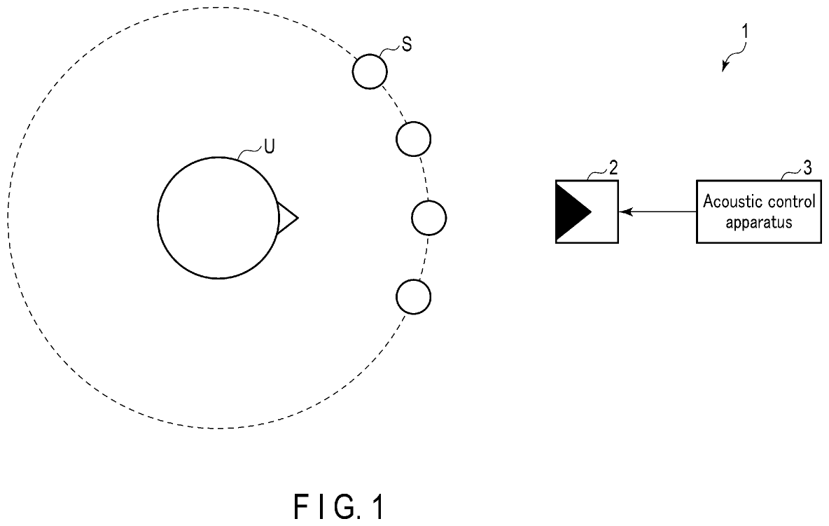

An embodiment will now be described with reference to the accompanying drawings. FIG. 1 is a view showing the configuration of an acoustic control system according to the embodiment. An acoustic control system 1 includes a loudspeaker 2 and an acoustic control apparatus 3.

The loudspeaker 2 is, for example, a sound source that is arranged in front of a user U and radiates a sound to the user U based on an acoustic signal input from the acoustic control apparatus 3. The loudspeaker 2 is an omnidirectional loudspeaker.

The acoustic control apparatus 3 is a computer configured to convolve a rotating sound source correction filter in the input acoustic signal and input the acoustic signal with the convolved filter to the loudspeaker 2. As will be described later in detail, the rotating sound source correction filter is a filter that is generated in consideration of the characteristic of a rotation sound when rotor blades attached to a flight vehicle such as a helicopter or a drone rotate. If a sound is reproduced from the loudspeaker 2 based on the acoustic signal in which the rotating sound source correction filter is convolved, a sound image S is localized in the elevation direction of the user U.

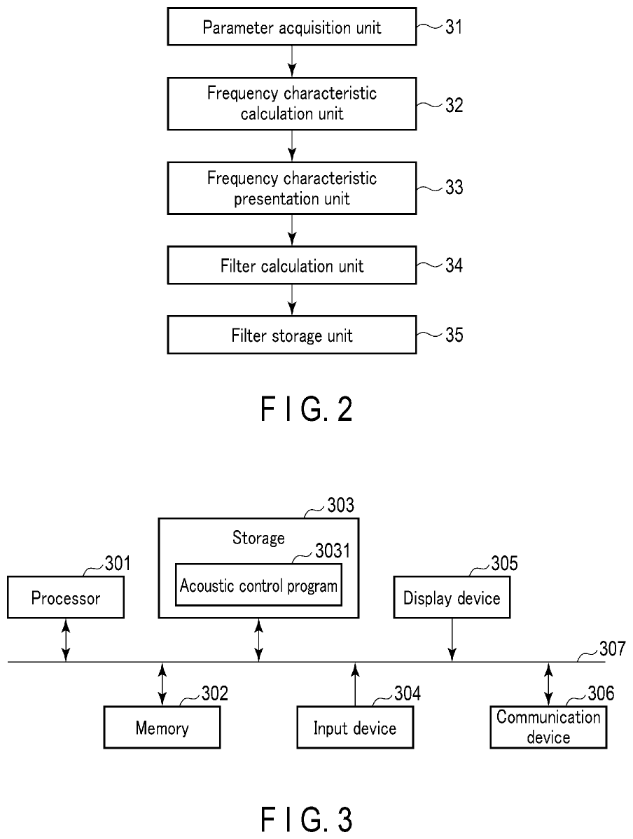

FIG. 2 is a block diagram showing the configuration of an example of the acoustic control apparatus 3. The acoustic control apparatus 3 includes a parameter acquisition unit 31, a frequency characteristic calculation unit 32, a frequency characteristic presentation unit 33, a filter calculation unit 34, and a filter storage unit 35.

The parameter acquisition unit 31 acquires various kinds of parameters necessary for calculation of the rotating sound source correction filter. The rotating sound source correction filter is calculated in consideration of the characteristic of a simulated rotating sound source. The simulated rotating sound source according to the embodiment is a simulated sound source that is arranged in a three-dimensional space and generates a sound having the same characteristics as a rotation sound of a rotor blade. The parameters include the number of point sound sources that constitute the simulated rotating sound source modeling a rotating sound source, the radius of the simulated rotating sound source, the horizontal distance from a sound receiving point to the center of the simulated rotating sound source, the vertical distance from a sound receiving point to the center of the simulated rotating sound source, the rotation mode of the simulated rotating sound source, the blade noise frequency of the simulated rotating sound source, and a low-frequency volume balance. The radius of the simulated rotating sound source is the distance from the center of the simulated rotating sound source to a point sound source. The horizontal distance is the distance between a sound receiving point and the center of the simulated rotating sound source on the XY plane in a case where X-, Y-, and Z-axes are set in the three-dimensional space. The vertical distance is the distance between a sound receiving point and the center of the simulated rotating sound source in the Z-axis direction in a case where X-, Y-, and Z-axes are set in the three-dimensional space. The rotation mode is a lobe mode in the circumferential direction of the moving blade of the simulated rotating sound source. The blade noise frequency is an angular frequency when the moving blade of the simulated rotating sound source is assumed to be rotated. However, in the design of the filter according to the embodiment, since the lobe mode is set for all frequencies, the rotation velocity of a blade need not be designated as a parameter. Filter characteristics obtained in this case indicate a gain and a phase in a case where an arbitrary blade noise frequency exists in each lobe mode. The low-frequency volume balance is a gain correction amount used to correct a low-frequency high-pass characteristic unique to the rotating sound source to be described later. These parameters will be described later in detail.

The frequency characteristic calculation unit 32 calculates the frequency characteristics of the filter based on the parameters acquired by the parameter acquisition unit 31. For example, based on the volume velocity of the sound radiated from the simulated rotating sound source and the transfer characteristic of the sound for each elevation angle, the frequency characteristic calculation unit 32 calculates the complex sound pressure of the sound that reaches from the simulated rotating sound source to the position of the user U and obtains the frequency characteristic of the filter from the calculated complex sound pressure. Calculation of the frequency characteristic will be described later.

The frequency characteristic presentation unit 33 displays the frequency characteristic of the filter for each elevation angle, which is calculated by the frequency characteristic calculation unit 32, on, for example, a display device, thereby presenting the frequency characteristic to the user. The user can select a frequency characteristic at a desired elevation angle from the presented frequency characteristics.

The filter calculation unit 34 calculates a rotating sound source correction filter to be convolved in an acoustic signal from the frequency characteristic of the elevation angle selected by the user. The filter calculation unit 34 performs inverse Fourier transformation of the product of the gain characteristic and the phase characteristic calculated from the frequency characteristic of the filter, thereby calculating a finite impulse response (FIR) filter to be convolved in an acoustic signal.

The filter storage unit 35 stores the rotating sound source correction filter calculated by the filter calculation unit 34. If the rotating sound source correction filter is convolved in the acoustic signal to be reproduced by the loudspeaker 2, sound image localization can be performed as if the rotor blade rotates in the elevation direction of the user U.

FIG. 3 is a view showing the hardware configuration of an example of the acoustic control apparatus 3. The acoustic control apparatus 3 can be a computer including, as hardware, a processor 301, a memory 302, a storage 303, an input device 304, a display device 305, and a communication device 306. The processor 301, the memory 302, the storage 303, the input device 304, the display device 305, and the communication device 306 are connected to a bus 307. The acoustic control apparatus 3 can be mounted in the control device of the loudspeaker 2, a personal computer, a smartphone, a tablet terminal or the like.

The processor 301 is a processor that controls the overall operation of the acoustic control apparatus 3. If the processor 301 executes, for example, an acoustic control program 3031 stored in the storage 303, the acoustic control apparatus 3 operates as the parameter acquisition unit 31, the frequency characteristic calculation unit 32, the frequency characteristic presentation unit 33, and the filter calculation unit 34. The processor 301 is, for example, a CPU. The processor 301 may be an MPU, a GPU, an ASIC, or an FPGA. The processor 301 may include a single CPU, or may include a plurality of CPUS.

The memory 302 includes a ROM and a RAM. The ROM is a nonvolatile memory. The ROM stores the activation program of the acoustic control apparatus 3, and the like. The RAM is a volatile memory. The RAM is used as, for example, a work memory at the time of processing in the processor 301.

The storage 303 is, for example, a storage such as a flash memory, a hard disk drive, or a solid state drive. The storage 303 stores various kinds of programs such as the acoustic control program 3031 to be executed by the processor 301. Also, the storage 303 can operate as the filter storage unit 35 that stores the rotating sound source correction filter.

The input device 304 is an input device such as a touch panel, a keyboard, or a mouse. If the input device 304 is operated, a signal according to the operation contents is input to the processor 301 via the bus 307. The processor 301 performs various kinds of processing in accordance with the signal. The input device 304 can be used to input the above-described parameters.

The display device 305 is a display device such as a liquid crystal display or an organic EL display. The display device 305 displays various kinds of images.

The communication device 306 is a communication device used by the acoustic control apparatus 3 to communicate with an external apparatus. The communication device 306 may be a communication device for wired communication, or may be a communication device for wireless communication.

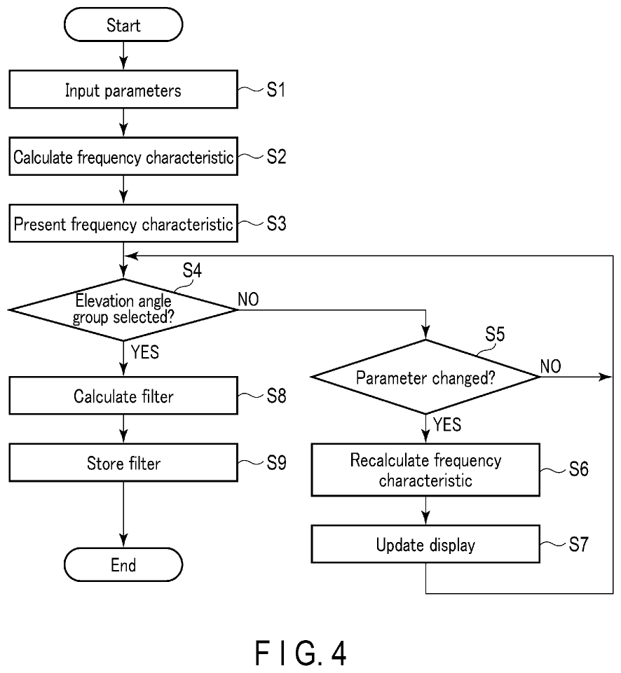

An acoustic control method according to the embodiment will be described below. FIG. 4 is a flowchart showing calculation processing of a rotating sound source correction filter by the acoustic control apparatus 3. Here, in the following explanation, let Lₚ be the number of point sound sources of the simulated rotating sound source, Ra be the radius of the simulated rotating sound source, RR be the horizontal distance from a sound receiving point to the center of the rotating sound source, high be the vertical distance from a sound receiving point to the center of the simulated rotating sound source, M be the rotation mode of the rotating sound source, w be the blade noise frequency of the simulated rotating sound source (virtually provided for all frequencies), and Low be the low-frequency volume balance. Furthermore, the description will be continued assuming that the vertical distance high of the rotating sound source, the number Lₚ of point sound sources, and the blade noise frequency ω are determined in advance.

In step S1, the parameter acquisition unit 31 acquires parameters based on, for example, an input from the user U. The input of parameters by the user U can be done in an input screen displayed on, for example, the display device 305. The initial values of the parameters may be decided in advance.

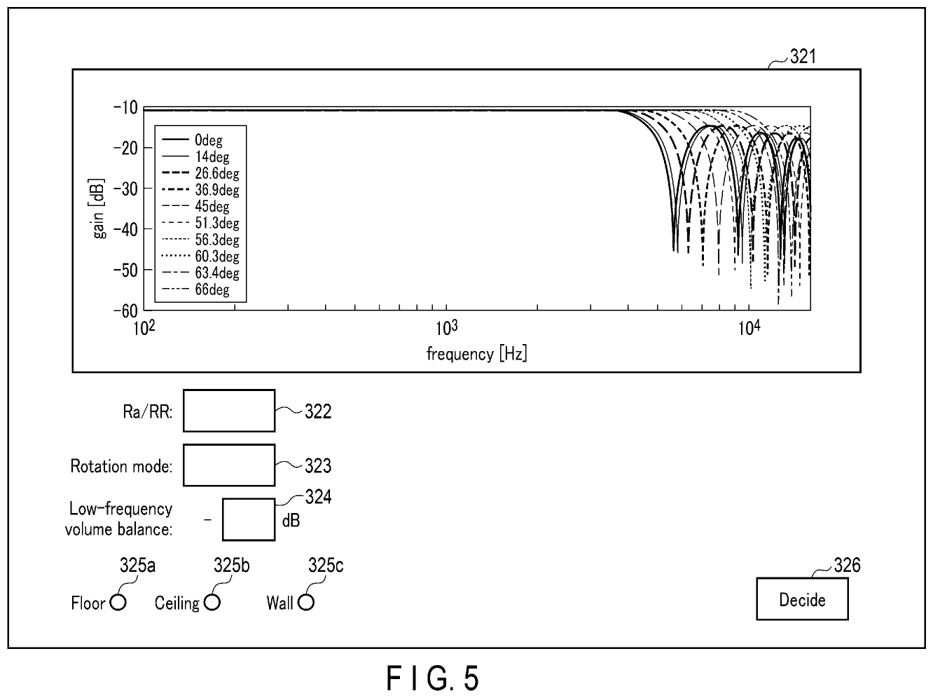

FIG. 5 is a view showing an input screen of an example. The input screen shown in FIG. 5 includes, for example, a frequency characteristic display region 321, an Ra/RR input field 322, a rotation mode input field 323, a low-frequency volume balance input field 324, space information input fields 325a, 325b, and 325c, and a decision button 326. Here, input fields and buttons other than those shown in FIG. 5 may be provided. For example, a high input field and an Lₚ input field may be provided in the input screen shown in FIG. 5.

The frequency characteristic display region 321 is a region in which a frequency characteristic calculated in accordance with the input of the parameters is displayed. As will be described later, the frequency characteristic is calculated for each elevation angle of the rotating sound source. In the frequency characteristic display region 321, the frequency characteristics calculated for the elevation angles are displayed in an overlapping state. Alternatively, in the frequency characteristic display region 321, the frequency characteristic calculated for each elevation angle may selectively be displayed.

The Ra/RR input field 322 is an input field used by the user to input the value of Ra/RR. The input of the value of Ra/RR can be performed by, for example, directly inputting a numerical value. Alternatively, the input of the value of Ra/RR may be performed by input using a user interface (UI) such as a slider, or may be performed by selecting one of several choices displayed in a dropdown list. For example, if one of the values Ra and RR is a fixed value, the input of the value of Ra/RR may be performed by inputting the value that is not the fixed value. FIG. 5 shows an example in which the value is input as a form of ratio Ra/RR. However, individual input fields may be provided for Ra and RR, as a matter of course.

The rotation mode input field 323 is an input field used by the user to input the value of the rotation mode M. The input of the value of M can be performed by, for example, directly inputting a numerical value. Alternatively, the input of M may be performed by selecting one of several choices displayed in a dropdown list.

The low-frequency volume balance input field 324 is an input field used by the user to input the value of the low-frequency volume balance Low. The input of Low can be performed by, for example, directly inputting a numerical value. Alternatively, the input of the low-frequency volume balance may be performed by input using a user interface (UI) such as a slider, or may be performed by selecting one of several choices displayed in a dropdown list.

The space information input fields 325a, 325b, and 325c are input fields used to input characteristic information of spaces where the acoustic control system 1 is used. The characteristic information of a space includes information representing whether the space is a free space or not. The information representing whether a space is a free space or not includes information representing the presence/absence of a floor, a ceiling, or a wall in the space. The space information input field 325a is, for example, a radio button used to select the presence/absence of a floor in the space. The space information input field 325b is, for example, a radio button used to select the presence/absence of a ceiling in the space. The space information input field 325c is, for example, a radio button used to select the presence/absence of a wall in the space. If the presence of a floor, a ceiling, or a wall is selected in the space information input fields 325a, 325b, and 325c, a frequency characteristic is calculated assuming that a floor, a ceiling, or a wall exists in the space. The position of the floor, the ceiling, or the wall may be fixed. Alternatively, if the presence of a floor, a ceiling, or a wall is selected in the space information input fields 325a, 325b, and 325c, a display field configured to input a position may be displayed, and the position of the floor, the ceiling, or the wall may be set in accordance with the input to the display field. On the other hand, if none of a floor, a ceiling, and a wall is selected in the space information input fields 325a, 325b, and 325c, a frequency characteristic is calculated assuming that the space is a free space.

The decision button 326 is a button used by the user to instruct the acoustic control apparatus 3 to execute filter calculation.

Referring back to FIG. 4, in step S2, the frequency characteristic calculation unit 32 calculates a frequency characteristic based on the parameters acquired in step S1. As for a parameter that is not input by the user, the frequency characteristic calculation unit 32 may calculate the frequency characteristic using an initial value. Calculation of the frequency characteristic will be described below.

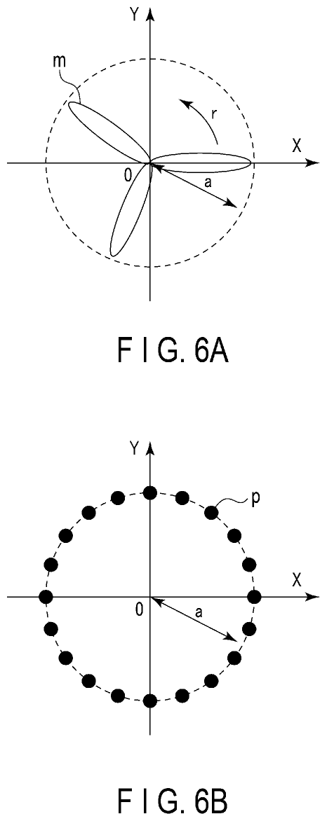

FIG. 6A is a schematic view of a rotating sound source of an example. For example, FIG. 6A is a schematic view of a rotating sound source including three moving blades. The moving blade radius of the rotating sound source shown in FIG. 6A is “a”. The blade noise frequency ω and the lobe mode M when the moving blade m of the rotating sound source rotates in a direction r at a rotation velocity Q are given by equations (1). B in equations (1) is the number of moving blades. Also, x is a noise target order. Here, the lobe mode M in equations (1) is a lobe mode in a case where the rotating sound source is assumed not to have a stationary blade. If the rotating sound source includes a stationary blade, the lobe mode M further includes a stationary blade term according to the number of stationary blades.

$$ω = Ω Bx \\ M = Bx \qquad ( 1 )$$

FIG. 6B is a schematic view of the simulated rotating sound source according to the embodiment. The rotating sound source shown in FIG. 6A is known to be modeled by Lₚ point sound sources p shown in FIG. 6B, which are arranged at equal intervals on a circumference that has the rotating shaft of the moving blades at a center 0 and has the radius “a” from a center 0. Here, if the number Lₚ of sound sources is sufficiently large, a complex volume velocity qp₁ of a point sound source pᵢ at a position i (i=1, . . . , Lₚ) can be expressed by equation (2) below. In equation (2), qp is a constant representing a complex amplitude. As indicated by equation (2), the complex volume velocity of each point sound source is represented by the product of an amplitude component e^{jωt} independent of the position of the point sound source and a phase delay component e^{-jMppi} based on the arrangement angle of the point sound source.

$${q}_{pi} = {q}_{p} {e}^{j ω t} {e}^{- jM {ϕ}_{pi}} \\ {ϕ}_{pi} = \frac{2 π}{{L}_{p}} ( i - 1 ) \qquad ( 2 )$$

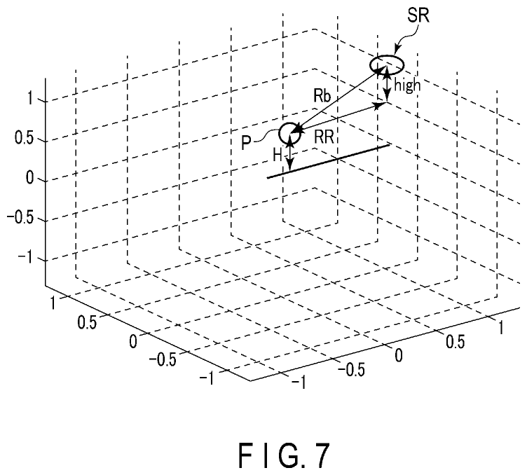

Assume that a simulated rotating sound source SR modeled like equation (2) exists at a position of the horizontal distance RR and the height “high” from a sound receiving point P, as shown in FIG. 7. A radius Ra of the simulated rotating sound source SR equals a moving blade radius “a”. Also, a distance Rb from the sound receiving point P to the center of the simulated rotating sound source SR, that is, a center O of a circle shown in FIG. 6B can be represented by

$$Rb = \sqrt{{RR}^{2} + {high}^{2}} \qquad ( 3 )$$

Letting Fᵢ be an acoustic transfer function of the sound between the sound receiving point P and each point sound source pᵢ, the complex sound pressure at the sound receiving point P when a sound is radiated from each point sound source pᵢ of the simulated rotating sound source SR can be represented by equation (4) below. That is, the complex sound pressure at the sound receiving point is obtained by adding the products of the complex volume velocities of the point sound sources pᵢ and the acoustic transfer function Fᵢ. The acoustic transfer function Fᵢ can be calculated from a microphone acquisition signal obtained by, for example, actually installing a sound source at a position i apart from the sound receiving point P by Rb, radiating a sound based on a random signal or a sound based on a Time stretched Pulse (TSP) signal from the sound source and collecting the sound by a microphone arranged at the position of the sound receiving point P. In this proposal setting, the position of each point sound source pᵢ can change depending on the radius Ra, the horizontal distance RR, and the height “high”. Hence, the acoustic transfer function Fᵢ may be calculated for each radius Ra, each horizontal distance RR, or each height “high”. Alternatively, the acoustic transfer function Fᵢ may be calculated by a simulation using acoustic analysis. In this case as well, the acoustic transfer function Fᵢ may be calculated for each radius Ra, each horizontal distance RR, or each height “high”.

$$p = {\sum }_{i = 1}^{{L}_{p}} {q}_{pi} {F}_{i} \qquad ( 4 )$$

The frequency characteristic calculation unit 32 calculates the complex volume velocity qpᵢ and the acoustic transfer function Fᵢ for each elevation angle based on the input parameters. The frequency characteristic calculation unit 32 then calculates the frequency characteristic of the filter for each elevation angle based on equation (4). At this time, the frequency characteristic calculation unit 32 executes correction for amplifying the gain under the first peak of the frequency characteristic of the filter for each elevation angle calculated based on equation (4) by −Low dB. More specifically, the frequency characteristic calculation unit 32 selects a frequency with the first peak and amplifies the gain under the selected frequency up to (first peak-Low) dB. The frequency characteristic calculation unit 32 then calculates the gain characteristic and the phase characteristic from the calculated frequency characteristic.

Also, if the elevation angle becomes large, that is, the height “high” becomes large, the distance Rb from the sound receiving point P to the center of the simulated rotating sound source SR also increases. If the distance Rb from the sound receiving point P to the center of the simulated rotating sound source SR increases, the sound pressure at the sound receiving point is attenuated. To suppress the distance attenuation of the sound pressure at the sound receiving point, the frequency characteristic calculation unit 32 may perform correction for multiplying the addition result of the volume velocity of each point sound source by Rb in accordance with

$$p = Rb {\sum }_{i = 1}^{{L}_{p}} {q}_{pi} {F}_{i} \qquad ( 5 )$$

Referring back to FIG. 4, in step S3, the frequency characteristic presentation unit 33 displays the frequency characteristic calculated by the frequency characteristic calculation unit 32 in the frequency characteristic display region 321 of the input screen. FIG. 5 shows an example in which the gain characteristic is displayed. The gain characteristic shown in FIG. 5 is a characteristic when the rotating sound source radius Ra is 0.05 m, the horizontal distance RR is 1.0 m, the rotation mode M is 2, and the low-frequency volume balance Low is 0 dB. The height “high” is changed to 10 steps from 0 in increments of RR/4. In this case, the elevation angles (=arctan (high/RR)) of the rotating sound source for the sound receiving point are 0 deg, 14 deg, 26.6 deg, 36.9 deg, 45 deg, 51.3 deg, 56.3 deg, 60.3 deg, 63.4 deg, and 66 deg. FIG. 5 shows an example in which only the gain characteristic is displayed in the frequency characteristic display region 321. As shown in FIG. 5, the frequency characteristic calculated based on the volume velocity of the rotating sound source has a notch characteristic that the gain abruptly lowers in a specific band. In general, a frequency band in which a feeling of vertical localization can be created is a notch frequency of 6 kHz to 12 kHz. As shown in FIG. 5, the characteristic of the notch frequency at 6 kHz to 12 kHz changes depending on the elevation angle, that is, the value of the height “high”. Although FIG. 5 shows an example in which only the gain characteristic is displayed, the phase characteristic may be displayed in addition to the gain characteristic.

In step S4, the filter calculation unit 34 determines whether an elevation angle group is selected. The elevation angle group here is the elevation angle group representing the frequency characteristic displayed in the frequency characteristic display region 321. Viewing the frequency characteristic shown in FIG. 5, the user confirms that the frequency characteristic desired by himself/herself is obtained and selects the decision button 326. In response to the selection of the decision button 326, the filter calculation unit 34 determines that the elevation angle group is selected. If it is not determined in step S4 that the elevation angle group is selected, the process advances to step S5. If it is determined in step S4 that the elevation angle group is selected, the process advances to step S8. Note that it may be determined whether not the elevation angle group but a specific elevation angle is selected.

In step S5, the parameter acquisition unit 31 determines whether a parameter is changed by the user. If the contents of one of the input fields shown in FIG. 5 are changed, it is determined that the parameter is changed. If it is determined in step S5 that no parameter is changed by the user, the process returns to step S4. If it is determined in step S5 that a parameter is changed by the user, the process advances to step S6.

In step S6, the frequency characteristic calculation unit 32 recalculates the frequency characteristic of the filter based on the changed parameters. In step S7, the frequency characteristic presentation unit 33 displays the recalculated frequency characteristic.

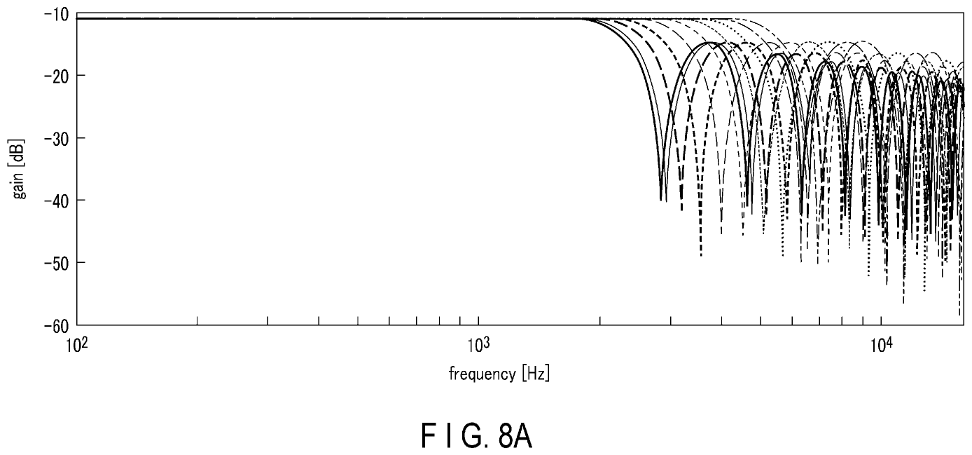

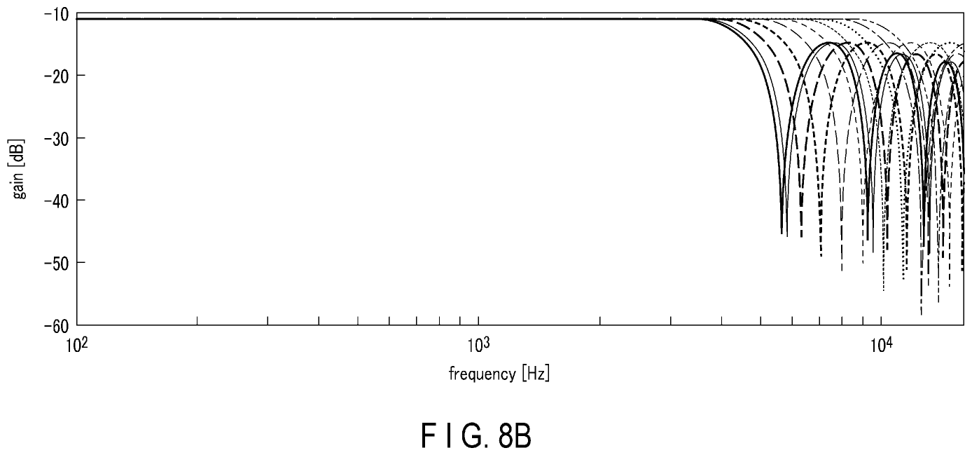

FIGS. 8A and 8B are views showing a change of the frequency characteristic by a change of Ra/RR. FIG. 8A shows a frequency characteristic when the rotating sound source radius Ra is 0.1 m, and the horizontal distance RR is 1.0 m, that is, when Ra/RR=0.1. On the other hand, FIG. 8B shows a frequency characteristic when the rotating sound source radius Ra is 0.05 m, and the horizontal distance RR is 1.0 m, that is, when Ra/RR=0.05. The change of Ra or RR corresponds to the change of the positional relationship between the sound receiving point P and each point sound source pᵢ. If the positional relationship between the sound receiving point P and teach point sound source pᵢ changes, the acoustic transfer function Fᵢ changes. This changes the notch frequency in the frequency characteristic. For example, if Ra/RR becomes small, the notch frequency shifts to the high frequency side, as shown in FIG. 8B.

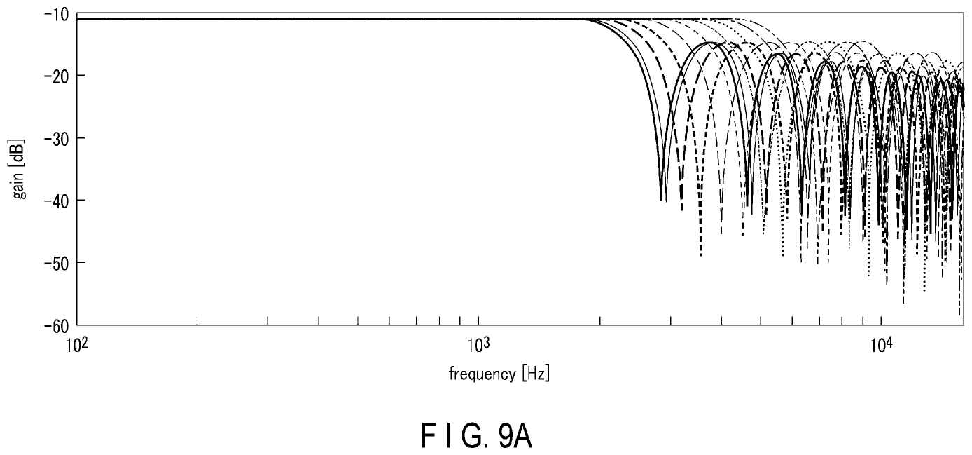

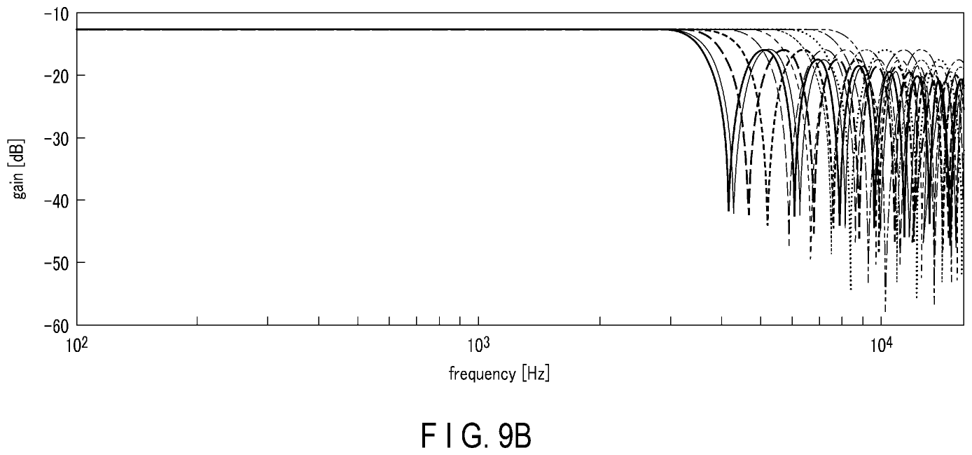

FIGS. 9A and 9B are views showing a change of the frequency characteristic by a change of the rotation mode. FIG. 9A shows a frequency characteristic when the rotation mode is 2. On the other hand, FIG. 9B shows a frequency characteristic when the rotation mode is 4. The change of the rotation mode corresponds to the change of the number of moving blades (and/or s stationary blades) of the rotating sound source. That is, if the rotation mode changes, the phase distribution of the complex volume velocity changes. This changes the notch frequency in the frequency characteristic. For example, if the rotation mode becomes large, the notch frequency shifts to the high frequency side, as shown in FIG. 9B.

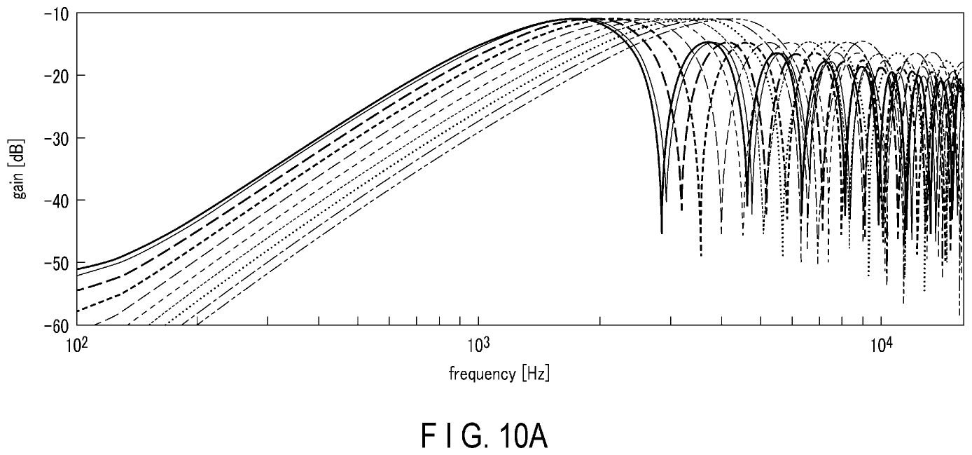

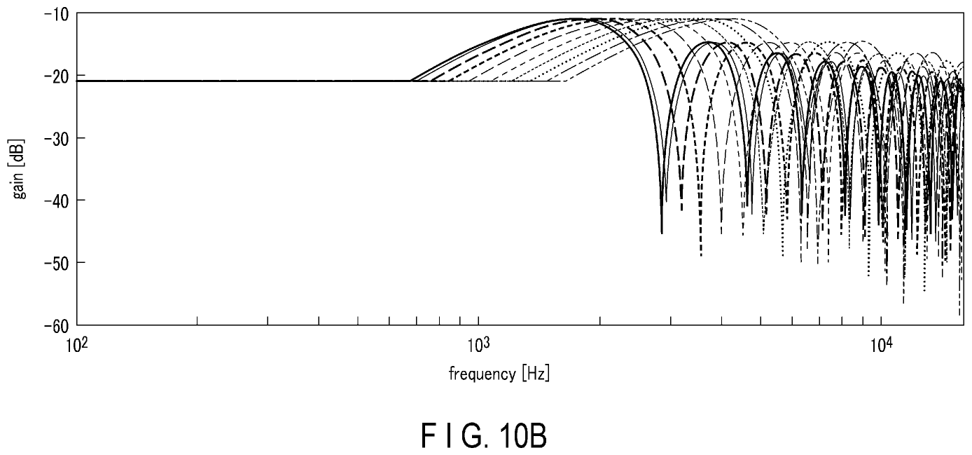

FIGS. 10A and 10B are views showing a change of the frequency characteristic by a change of the low-frequency volume balance. FIG. 10A shows a frequency characteristic when the low-frequency volume balance is not corrected. On the other hand, FIG. 10B shows a frequency characteristic when the low-frequency volume balance Low is −10 dB, and the rotation mode is 4. If the low-frequency volume balance is not corrected, the frequency characteristic of the filter has a high-pass filter characteristic that the gain in the low frequency range largely lowers, as shown in FIG. 10A. Hence, as shown in FIG. 10B, the notch characteristic unique to the rotating sound source can be enhanced by amplifying the gain under the first peak to a value obtained by lowering the gain at the first peak by −Low. If the low-frequency volume balance is changed, the degree of enhancement of the notch characteristic changes.

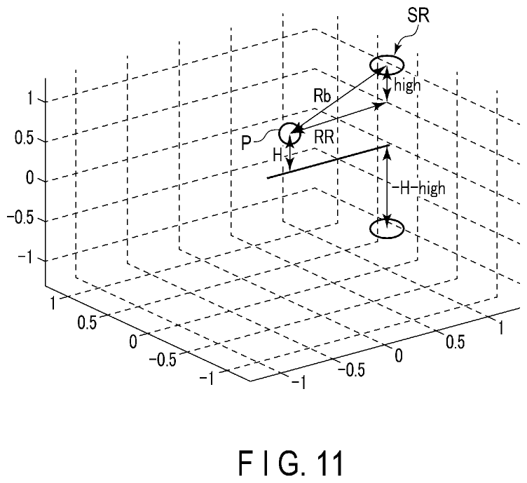

FIG. 11 is a view showing how to calculate the frequency characteristic of a filter in the presence of a floor. If a sound is radiated from the sound source SR in a space with a floor, the sound received at the sound receiving point includes not only a sound directly received from the sound source SR but also a sound reflected by the floor. Hence, to calculate the frequency characteristic of the filter, the reflected sound from the floor needs to be taken into consideration. The reflected sound from the floor can be considered as a sound from a simulated rotating sound source SR2 that is located at a position plane-symmetric to the simulated rotating sound source SR with respect to the floor. For example, if the sound receiving point P is at a height H, it can be considered that the simulated rotating sound source SR2 is located at a position where the horizontal distance is RR, and the height from the floor is-H-high. FIG. 11 shows an example of a floor. In a case where a ceiling exists or a wall exists as well, the frequency characteristic of the filter is calculated assuming that another rotating sound source exists at a position plane-symmetric to the simulated rotating sound source SR with respect to the ceiling or wall.

Referring back to FIG. 4, in step S8, the filter calculation unit 34 calculates a filter using the frequency characteristic of the filter with the elevation angle selected by the user. In step S9, the filter calculation unit 34 stores the created filter in the filter storage unit 35. After that, the processing shown in FIG. 4 is ended.

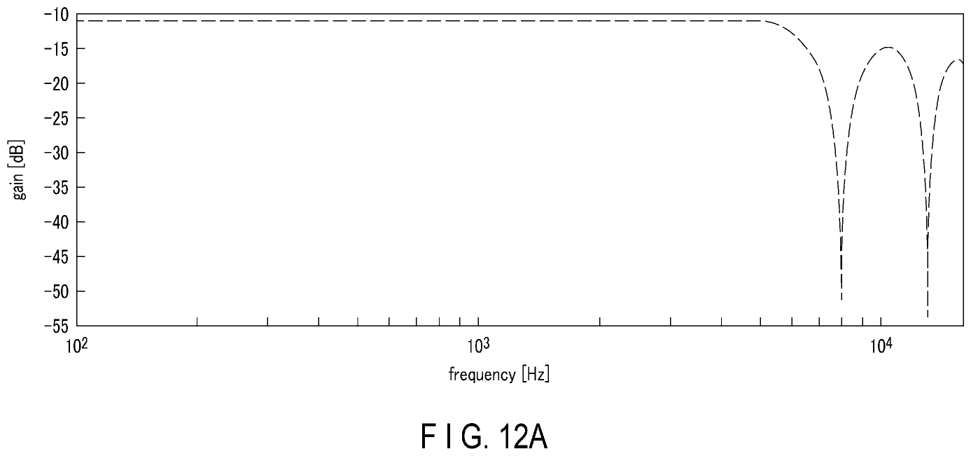

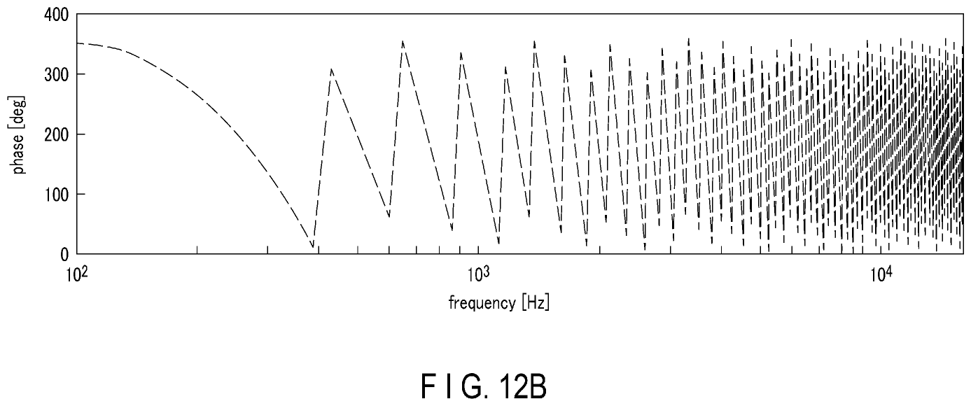

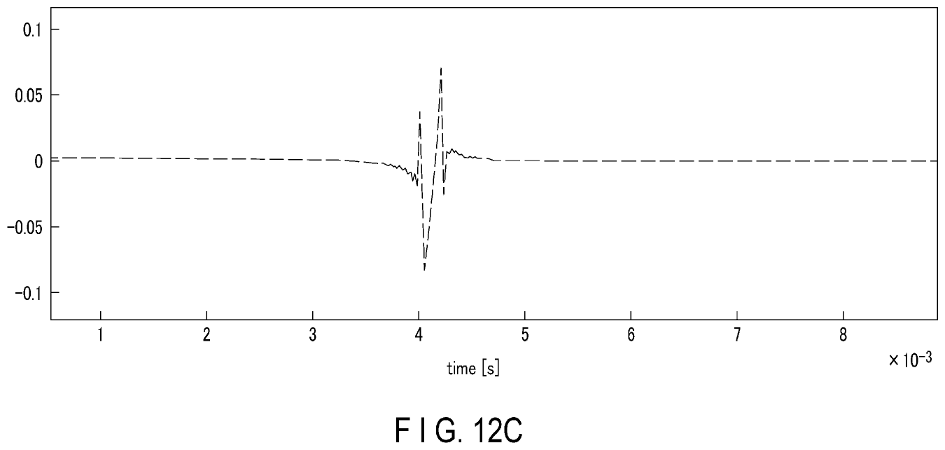

An example of calculation of the filter will be described below. In the following description, it is assumed that an elevation angle of 45 deg is selected by the user. FIG. 12A is a Bode diagram showing a gain characteristic calculated from the frequency characteristic of a filter with an elevation angle of 45 deg. FIG. 12B is a Bode diagram showing a phase characteristic calculated from the frequency characteristic of a filter with an elevation angle of 45 deg.

When calculating the filter, the filter calculation unit 34 first calculates the product of the gain characteristic and the phase characteristic. The filter calculation unit 34 then performs inverse FFT of the product of the gain characteristic and the phase characteristic, thereby calculating, as a rotating sound source correction filter, the time response of a filter having the frequency characteristic shown in the Bode diagrams of FIGS. 12A and 12B, that is, an FIR filter. FIG. 12C is a view showing the time characteristic of a rotating sound source correction filter for an elevation angle of 45 deg created from the gain characteristic shown in FIG. 12A and the phase characteristic shown in FIG. 12B. If an acoustic signal in which the rotating sound source correction filter having the characteristic shown in FIG. 12C is convolved is reproduced from the loudspeaker 2, the user U can perceive the same sound as that of the rotating sound source located at the elevation angle of 45 deg. In this way, sound image localization in the elevation direction can be implemented.

As described above, according to the embodiment, a filter reflecting the characteristic of a rotating sound source is convolved in an acoustic signal to be input to an omnidirectional loudspeaker, thereby implementing sound image localization simulating the rotating sound source only by the omnidirectional loudspeaker. It can easily be found from what height the sound from the rotating sound source has arrived, this is effective for sound image localization in the elevation direction of the user. In addition, the sound from the rotating sound source can be simulated by the omnidirectional loudspeaker. That is, in the embodiment, it is not necessary to arrange a loudspeaker directed in the elevation direction to implement sound image localization in the elevation direction, and sound image localization in the elevation direction can be implemented by a simple configuration.

Also, the ratio Ra/RR of the rotating sound source radius Ra and the horizontal distance RR from the sound receiving point to the center of the rotating sound source, the vertical distance high from the sound receiving point to the center of the rotating sound source, and the rotation mode M of the rotating sound source, which are the parameters used to simulate the rotating sound source, can be adjusted by the user. Thus, sound image localization simulating a rotating sound source with various positions and/or structures can be performed.

Also, in the case of the original rotating sound source, if the height “high” becomes large, the sound pressure at the sound receiving point is abruptly attenuated. To the contrary, if the addition result of the volume velocity is multiplied by the distance Rb to suppress the attenuation of the sound pressure caused by the increase of “high”, that is, the increase of the distance Rb, the user can hear a loud sound even if the height “high” is large.

Here, in the embodiment, the height “high” is determined in advance. As described above, the height “high” may be set by the user, too. In this case, the frequency characteristic of the filter only for the height “high”, that is, the elevation angle set by the user may be calculated.

Also, in the embodiment, the user can select a desired parameter set while viewing the frequency characteristic of the filter displayed on the display device. However, the processing may be changed such that the user selects a desired parameter set while hearing a sound that has actually undergone sound image localization. In this case, processing up to the calculation of the filter for each elevation angle is performed based on the parameters acquired in step S1, and the loudspeaker 2 actually reproduces a sound based on the calculated filter. The user can select a desired parameter set while hearing this sound.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic control apparatus comprising a processor including hardware configured to:
calculate a frequency characteristic of a filter to be convolved in an acoustic signal to be input to a loudspeaker from 1) a complex volume velocity of a sound radiated from each point sound source based on the number of point sound sources in a simulated rotating sound source represented by a plurality of point sound sources arranged on a circumference and a lobe mode of the simulated rotating sound source, and 2) an acoustic transfer function between a sound receiving point and each point sound source in a space in which the sound receiving point and the simulated rotating sound source are arranged, which is based on a radius of the circle, a horizontal distance between a center of the circle and the sound receiving point, and a vertical distance between the center of the circle and the sound receiving point;
calculate the filter from the frequency characteristic of the filter; and
store the filter in a storage.

2. The apparatus according to claim 1, wherein the processor corrects the frequency characteristic in accordance with a distance between the center of the circle and the sound receiving point.

3. The apparatus according to claim 1, wherein the processor performs correction for amplifying a gain in a frequency band not more than a first peak in the frequency characteristic from a value of the gain at the first peak to a value lowered by a designated value.

4. The apparatus according to claim 1, wherein the processor
acquires the lobe mode of the simulated rotating sound source, the radius of the circle, and the horizontal distance between the center of the circle and the sound receiving point based on an input of a user, and
calculates the frequency characteristic based on the lobe mode of the simulated rotating sound source, the radius of the circle, and the horizontal distance between the center of the circle and the sound receiving point, which are input by the user.

5. The apparatus according to claim 4, wherein the processor
calculates the frequency characteristic based on a plurality of vertical distances between the center of the circle and the sound receiving point, and
calculates the filter from the frequency characteristic corresponding to a vertical distance selected by the user.

6. The apparatus according to claim 4, wherein the processor
further acquires characteristic information of the space, and
calculates the frequency characteristic based on the characteristic information of the space.

7. An acoustic control method comprising:
calculating a frequency characteristic of a filter to be convolved in an acoustic signal to be input to a loudspeaker from 1) a complex volume velocity of a sound radiated from each point sound source based on the number of point sound sources in a simulated rotating sound source represented by a plurality of point sound sources arranged on a circumference and a lobe mode of the simulated rotating sound source, and 2) an acoustic transfer function between a sound receiving point and each point sound source in a space in which the sound receiving point and the simulated rotating sound source are arranged, which is based on a radius of the circle, a horizontal distance between a center of the circle and the sound receiving point, and a vertical distance between the center of the circle and the sound receiving point; and
calculating the filter from the frequency characteristic of the filter.

8. A non-transitory computer-readable medium storing an acoustic control program configured to cause a computer to execute:
calculating a frequency characteristic of a filter to be convolved in an acoustic signal to be input to a loudspeaker from 1) a complex volume velocity of a sound radiated from each point sound source based on the number of point sound sources in a simulated rotating sound source represented by a plurality of point sound sources arranged on a circumference and a lobe mode of the simulated rotating sound source, and 2) an acoustic transfer function between a sound receiving point and each point sound source in a space in which the sound receiving point and the simulated rotating sound source are arranged, which is based on a radius of the circle, a horizontal distance between a center of the circle and the sound receiving point, and a vertical distance between the center of the circle and the sound receiving point; and
calculating the filter from the frequency characteristic of the filter.
